(19) United States
(12) Patent Application Publication
(10) Pub. No.: US 2017/0367362 A1
(43) Pub. Date: Dec. 28, 2017

(54) MILK POWDER WITH IMPROVED MOUTH FEEL

(71) Applicant: NESTEC S.A., Vevey (CH)

(72) Inventors: Markus Kreuss, Freimettigen (CH); Nicole Rohrer, Reichenbach (CH); Christopher Joseph Etienne Schmitt, Servion (CH); Eric Kolodziejczyk, Vevey (CH); Madansinh Nathusinh Vaghela, Bakersfield, CA (US)

(21) Appl. No.: 15/538,132

(22) PCT Filed: Dec. 21, 2015
(86) PCT No.: PCT/EP2015/080846

§ 371 Date: Jun. 20, 2017

(30) Foreign Application Priority Data
Dec. 22, 2014 (EP) 14199606.6

(51) Int. Cl. A23C 9/15; A23C 1/16; A23C 1/04; A23C 1/12; A23J 3/08; A23J 1/20

(52) U.S. Cl. CPC A23C 9/1508; A23J 3/08; A23J 1/207; A23C 1/04; A23C 1/12; A23C 1/16

(57) ABSTRACT

The present invention relates to a milk powder comprising caseins and whey proteins wherein the powder upon reconstitution in an aqueous medium comprises casein-whey protein/fat aggregates having a mean diameter value Dv50 of at least 1 mycrom as measured by laser diffraction. The invention also relates to a process for preparing a milk powder including the steps of providing a liquid milk concentrate at T<25° C., adjusting pH to 5.7-6.4, heating at 80-150° C. for 3-300 s, cooling to below 70° C. and optionally readjusting the pH to between 6.5-6.8, drying the composition, and the milk powder obtained by this process for producing growing up milks, culinary sauces, coffee mixes, tea and coffee creamer or cocoa-malt beverages.

### FIELD OF THE INVENTION

The present invention relates to dairy products.

In particular, the invention is concerned with milk powder compositions comprising a protein complex which contributes to the improvement of creaminess, mouthfeel and texture, in particular of products based on lower and no fat formulations. A method of producing such milk powder products and the products obtainable from the method are also part of the present invention.

### BACKGROUND

Powdered milk or dried milk is a manufactured dairy product made by evaporating milk to dryness. It involves the gentle removal of water at the lowest possible cost under stringent hygiene conditions while retaining all the desirable natural properties of the milk—color, flavor, solubility, nutritional value. Whole (full cream) milk contains, typically, about 87% water and skim milk contains about 91% water. During milk powder manufacture, this water is removed by boiling the milk under reduced pressure at low temperature in a process known as evaporation. The resulting concentrated milk is then sprayed in a fine mist into hot air to remove further moisture and so give a powder. Alternatively, this could be achieved by freeze drying or roller drying of the concentrated milk.

Powdered milk is usually made by spray drying nonfat skimmed milk, whole milk, buttermilk or whey. Pasteurized milk is first concentrated in an evaporator to approximately 50% milk solids. The resulting concentrated milk is then sprayed into a heated chamber where the water almost instantly evaporates, leaving fine particles of powdered milk solids.

Mouthfeel and creaminess as well as lower or reduced fat are key drivers of consumer liking for dairy based products such as coffee mixes or coffee enhancers as well as a high number of other products.

Today, there is a challenge to either increase or retain the mouthfeel/creaminess of powders when fat is reduced or removed. Thus the objective of the present invention is to use all-natural formulation or ideally by the product matrix itself, instead of adding ingredients to the product, particularly in low and no fat products.

It is known since 1980's that a slight pH adjustment of native fresh milk prior to heat treatment results in change of aggregation behavior between casein micelles and whey proteins. However, the pH range that was explored in milk never went down lower than pH 6.3 [F. Guyomarc'h. 2006. Formation of heat-induced protein aggregates in milk as a means to recover the whey protein fraction in cheese manufacture, and potential of heat-treating milk at alkaline pH values in order to keep its rennet coagulation properties. A review. Lait, 86, 1-20.]

It was surprisingly found that by mild acidification in the area of pH 5.7-6.3, the whey proteins in combination of controlled heat treatment (temperature and hold time) form complexes with the casein micelles, which results in increased colloidal particle size, water binding and overall viscosity. The problem also addressed by this invention is maintaining the structure and function after drying the composition. It was observed that current high pressure spray drying conditions for standard milk powder manufacture resulted in high shear effect that destroyed the controlled aggregation of proteins and thus the functionality during spray drying process.

It is object of present invention to provide an improved process to provide a milk powder that provides protection against loss of structure and function of aggregated proteins.

Adding thickeners (e.g. hydrocolloids, starches) has shown no big success due to unexpected texture change, flavor loss, increased length of ingredient list and also increased formulation costs.

EP0333288 relates to spray dried milk powder product and process for its preparation. It was found that a spray dried whole-milk powder with a coarser fat dispersion can be prepared by causing the spraying to be effected in such conditions that a considerable portion of the fat in the pre-concentrated milk product to be dried is in the solid state.

EP1127494 relates to a process for the preparation of fat-containing milk powder.

Thus it is object of the present invention to improve mouthfeel/texture/thickness/creaminess of the current products in the market. It is also an object of the present invention to keep mouthfeel/texture/thickness/creaminess of a product constant while reducing fat content. Furthermore it is also object of the present invention to keep mouthfeel/texture/thickness/creaminess of a product constant while reducing or eliminating thickening agents/stabilizers, e.g. hydrocolloids or starch.

### SUMMARY OF THE INVENTION

The present invention relates to a milk powder, manufactured by a suitable drying process upon reconstitution in an aqueous medium comprises particles having a mean diameter value Dv50 of at least 1 μm as measured by laser diffraction. The mean diameter Dv50 ranges from 1 μm-60 μm.

One aspect of the present invention relates to a reconstituted spray dried milk powder at total solids of 35% (w/w) exhibits a shear viscosity of at least 1000 mPa·s measured at a shear stress of 10 Pa, a shear viscosity of at least 400 mPa·s measured at a shear rate of 100 l/s and a viscosity ratio between these two conditions of at least 1.3 as determined on flow curves obtained with a rheometer at 20° C.

Another aspect of the present invention relates to a process for preparing a milk powder comprising the steps of:
a) Providing a liquid milk concentrate at temperature below 25° C.;
b) Adjusting pH to 5.7 and 6.4;
c) Heat treating the composition at 80-150° C. for 3-300 seconds;
d) Cooling the composition below 70° C. and optionally readjusting the pH between 6.5 and 6.8
e) Drying the composition after step d.

### DESCRIPTION OF THE FIGURES

FIG. 1 shows differential interference contrast light microscopy images of spray-dried milk powders reconstituted in water. A: standard milk powder composition wherein the pH of homogenized liquid milk concentrate was measured to be 6.5, and the composition was heated up to 85° C. for 15 seconds. B: sample of present invention, the composition wherein the pH of homogenized liquid milk concentrate was adjusted to 6.1 and the composition was heated up to 90° C. for 150 seconds. Sample of present invention shows controlled aggregate formation which is a microscopy signature of protein complex formation at molecular scale. Scale bars are 20 microns.

FIG. 2 shows confocal scanning laser micrographs of spray dried milk powders reconstituted in water. A: standard milk powder according to reference 2 where the proteins have been labelled with fast green fluorescent dye. B: sample 1 of present invention where the proteins have been labelled with fast green fluorescent dye. C: standard milk powder according to reference 2 where the fat has been labelled with Nile red fluorescent dye. D: sample 1 of present invention where the fat has been labelled with Nile red fluorescent dye. Scale bars are 20 microns. From this microscopy analysis, it is obvious that the spray dried milk powder according to the invention is exhibiting numerous milk protein aggregates which are obtained via protein complex formation and are interacting with the fat droplets (FIG. 2B, D). Such type of aggregated protein structures interacting with fat droplet is not seen in the reference sample (FIG. 2A, C) where only a thin layer of protein is observed around the fat droplets. This leads too much smaller particle size as compared to the product of the invention.

FIG. 3 shows light micrographs of sections of spray dried milk powders embedded in historesin and stained with toluidine blue. A: standard milk powder according to reference 2. B: sample 1 of present invention. Scale bar is 150 microns. The standard milk powder is characterized by the presence of numerous air cavities entrapped in the powder granules leading to an air volume fraction of 6%. Far less air cavities are observed in the powder of the invention leading to an air volume fraction of less than 1%.

FIG. 4 shows flow curves obtained upon reconstitution of spray dried milk powders to a total solids concentration of 50% (w/w). The critical viscosity values corresponding to a shear stress of 10 Pa and a shear rate of 100 l/s are indicated on the charts. A: standard milk powder according to reference 2 but produced at 50% total solids. B: sample 2 of present invention as in FIG. 1. From the flow curves, it could be determined that the reconstituted spray dried standard milk powder exhibited a shear viscosity of 280 mPa·s at a shear stress of 10 Pa and a shear viscosity of 218 mPa·s at a shear rate of 100 l/s. The viscosity ratio was 1.28. For the product of the invention, it was determined that the reconstituted spray dried milk powder exhibited a shear viscosity of 6300 mPa·s at a shear stress of 10 Pa and a shear viscosity of 3250 mPa·s at a shear rate of 100 l/s. The viscosity ratio was thus 1.94.

FIG. 5 shows particle size distributions of spray dried powders according to reference 2 or sample 1 after each step of the process from raw milk (12% solids) to concentrated milk (35% solids) as well as the corresponding powders reconstituted to 35% solids. The values above the charts are the corresponding shear viscosity values measured at a shear rate of 100 l/s. It is clear that for the spray dried milk powder of the invention, the Dv50 was at least 1 micron and that the shear viscosity at a shear rate of 100 l/s was higher than 400 mPa·s.

FIG. 6 shows examples of compositions that do not exhibit the described benefit when the process is carried out outside the claimed invention. For instance FIG. 6A shows a composition at 30% total solids wherein the pH of homogenized liquid milk concentrate is adjusted to 6.0 and the composition is heated up to 76° C. for 120 seconds. This process did not result in any viscous dispersion, the particle size distribution Dv50 was 0.380 micron. Microscopic image was homogeneously fluorescent, indicating no aggregates noticeable in the composition. Similarly FIG. 6B shows a composition at 30% total solids wherein the pH of homogenized liquid milk concentrate is adjusted to 6.0 and the composition is heated up to 105° C. for 300 seconds. This process resulted in a highly coagulated solution, the particle size distribution Dv50 was 41.462 μm. Microscopic image showed a fully coagulated system with no individual particles visible.

FIG. 7 shows the particle size distribution of sample 3 of the present invention after reconstitution of the powder to 10% (w/w).

FIG. 8 shows the particle size distribution of sample 4 of the present invention after reconstitution of the powder to 10% (w/w).

FIG. 9 shows flow curves at 20° C. of samples 3 (A) and 4 (B) of the present invention after reconstitution of the spray dried powder to 50% (w/w). The flow curves exhibit a characteristic shear thinning behavior indicating presence of a specific structure.

FIG. 10 shows comparative profiling of two samples as described below in Table 6

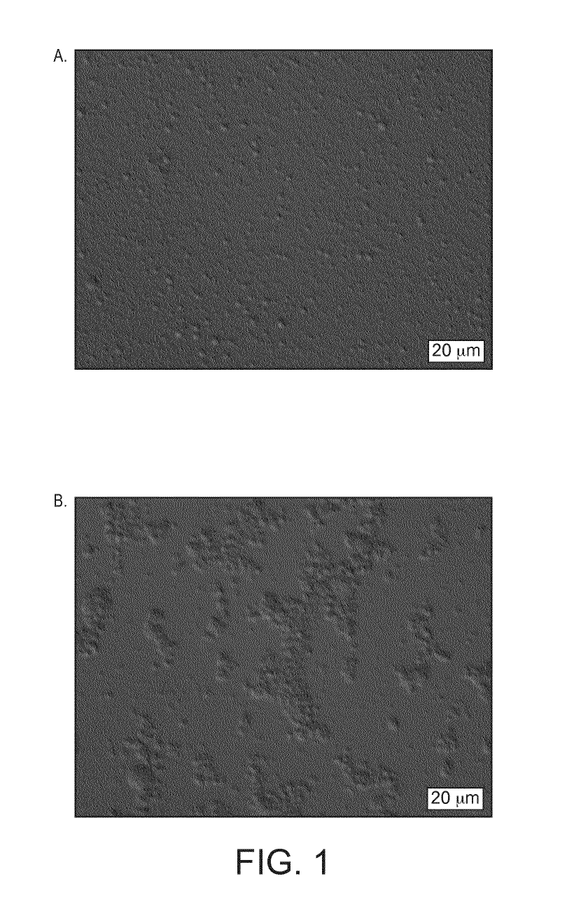

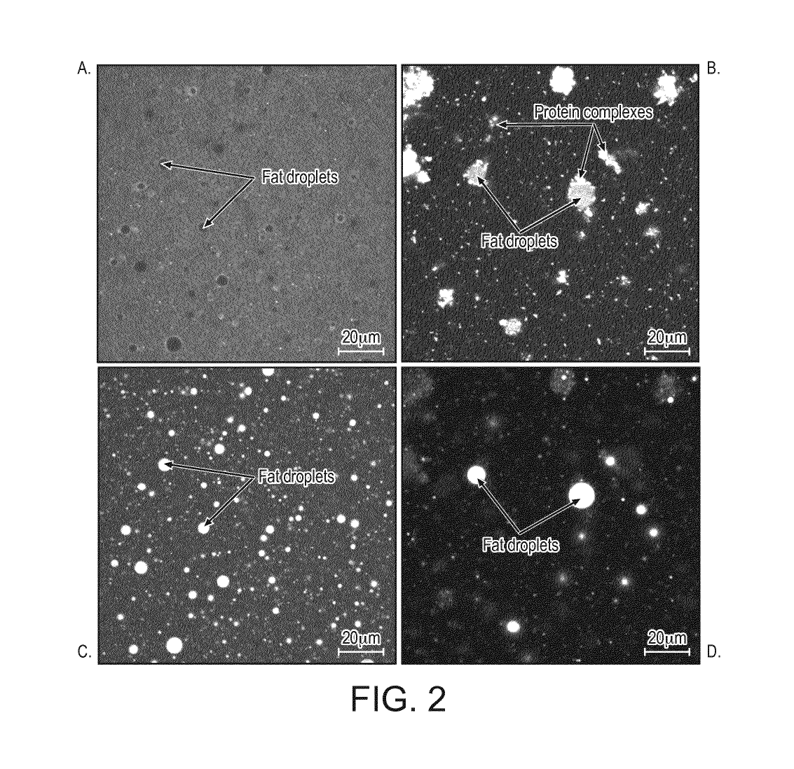

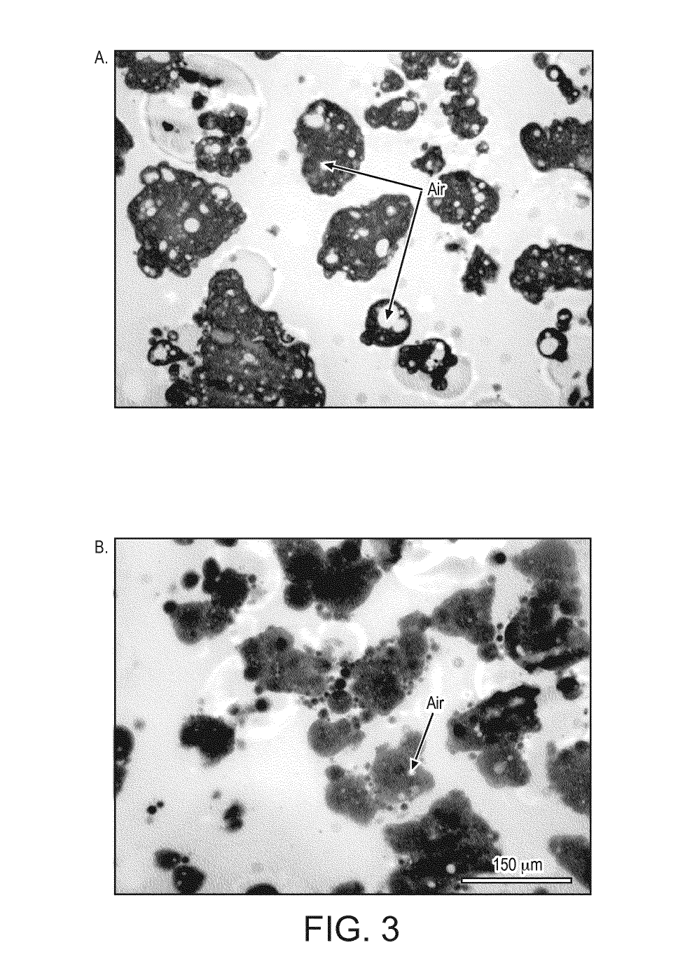

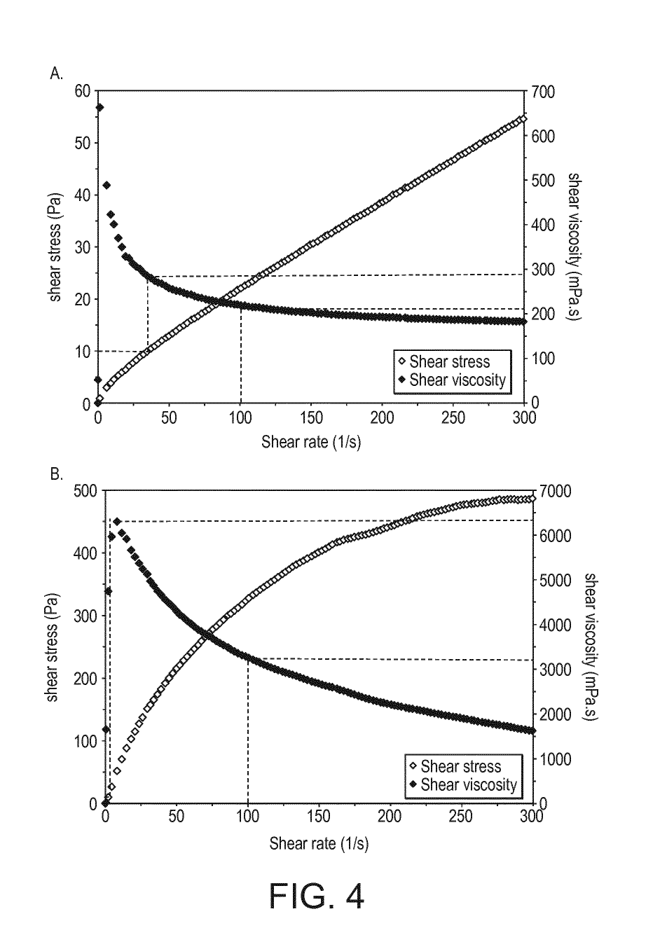

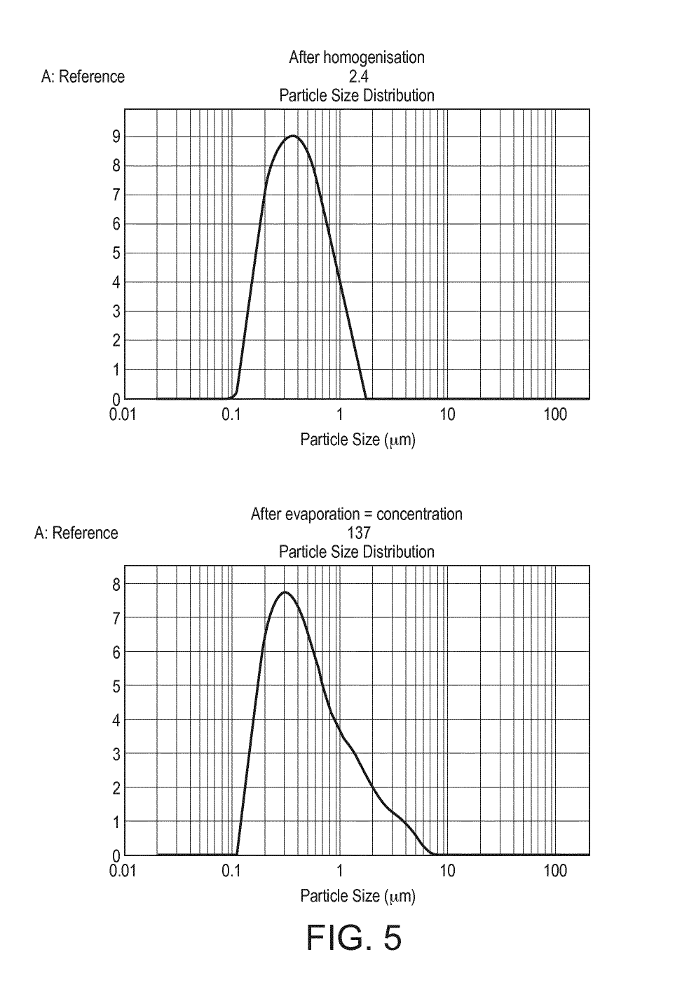

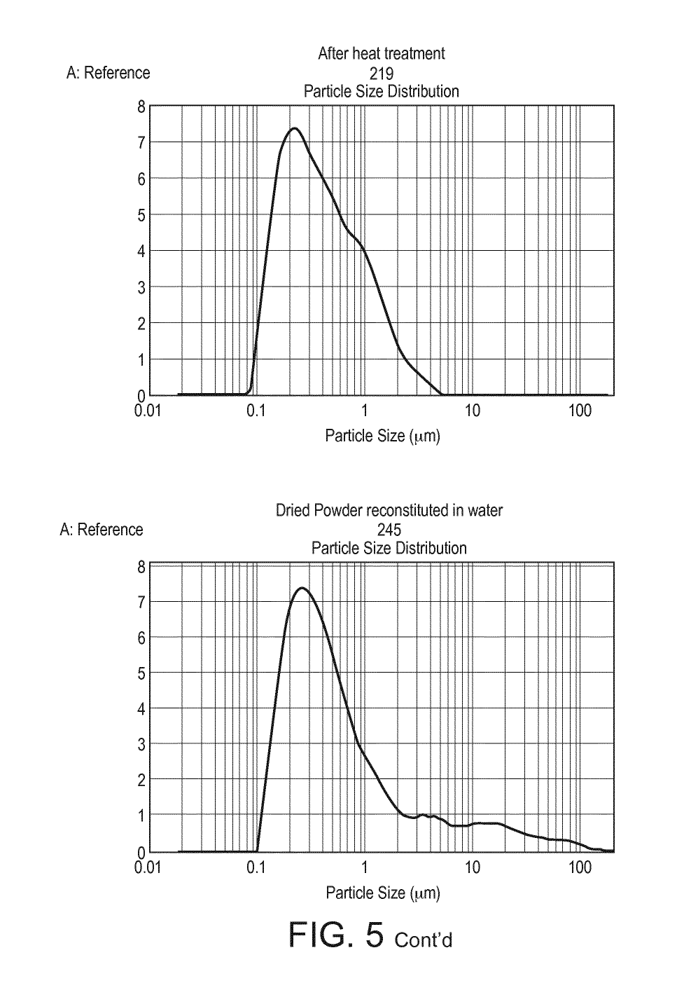

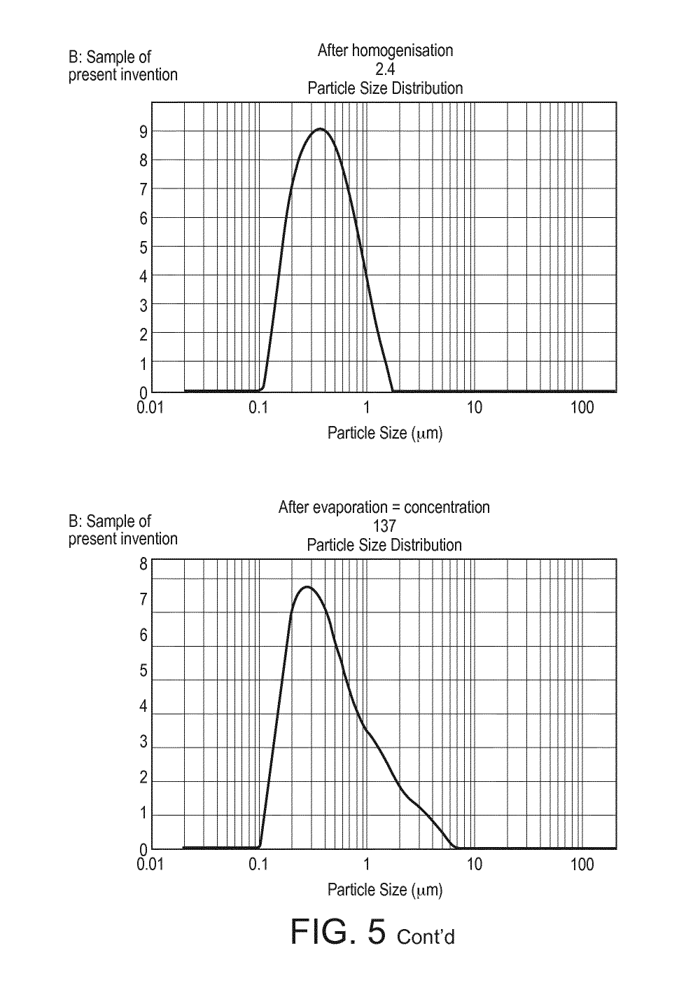

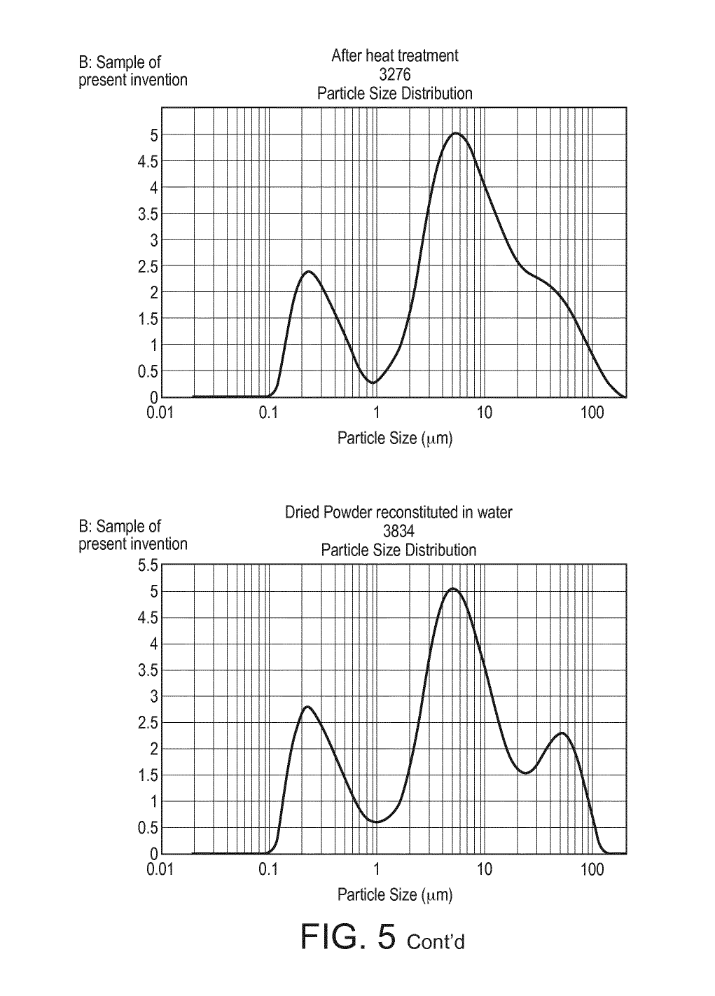

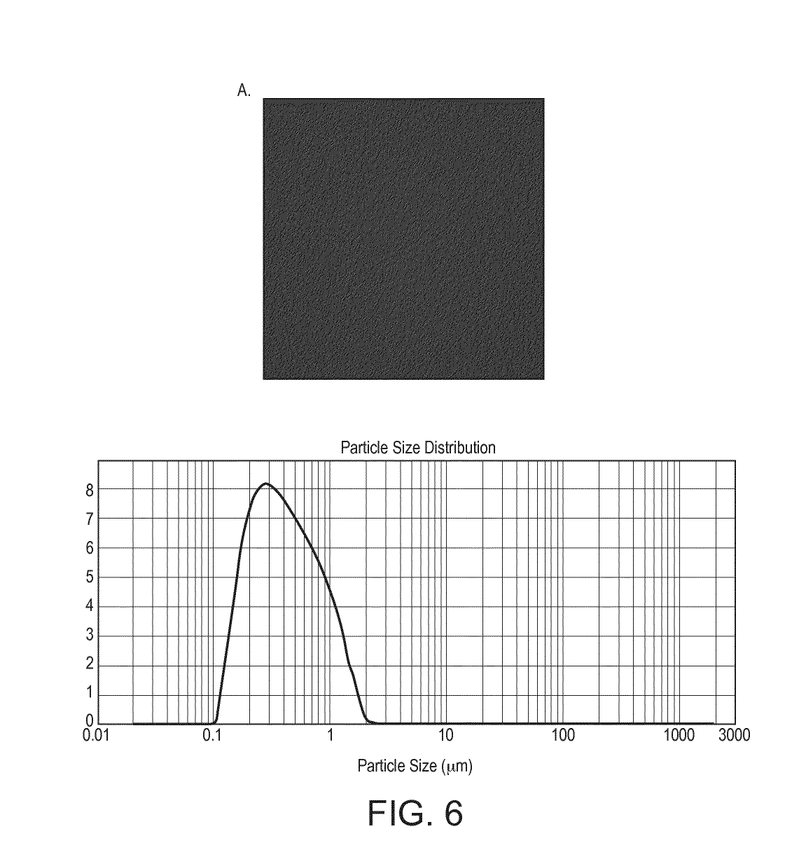

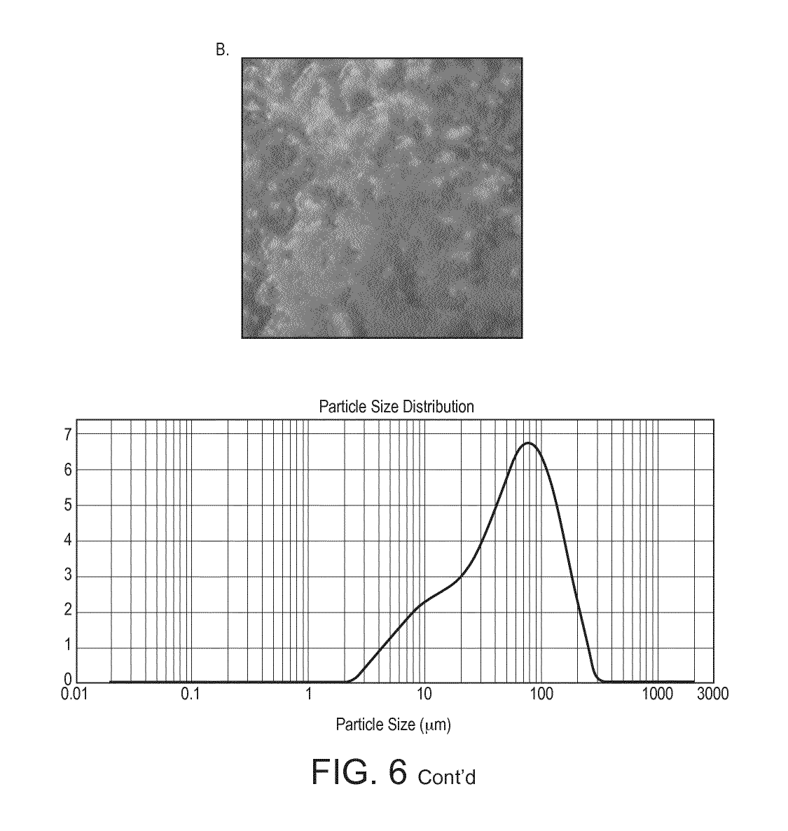

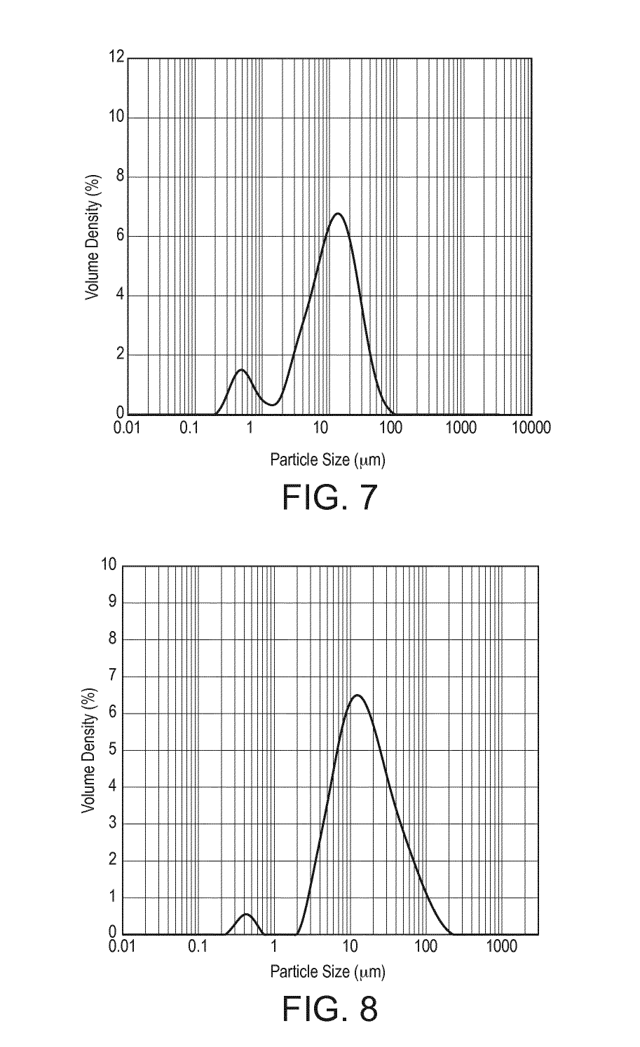

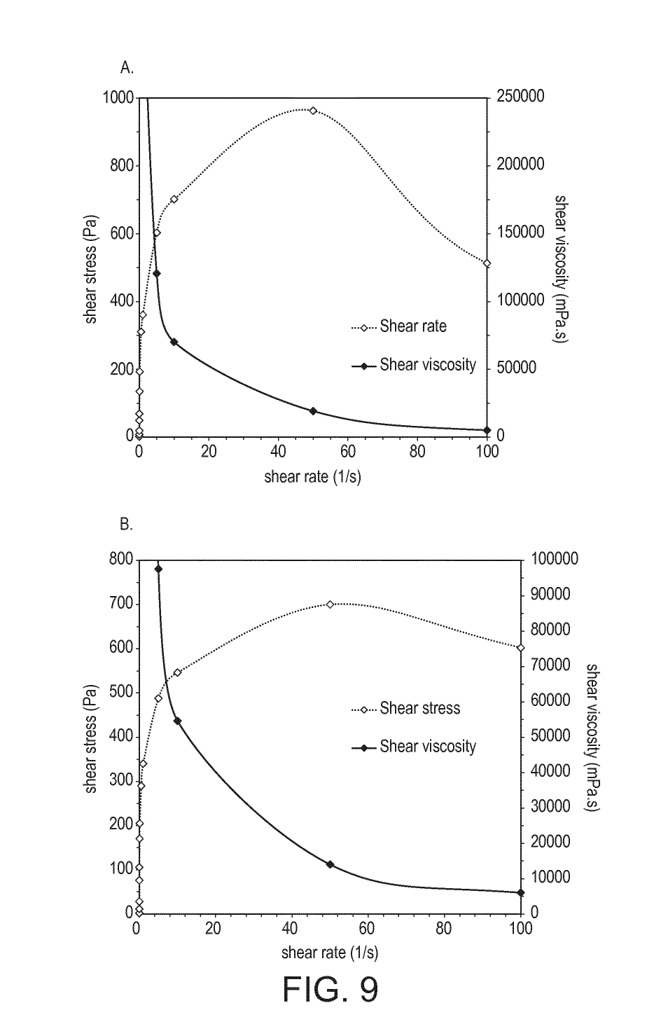

### DETAILED DESCRIPTION

The term “particles having mean diameter value Dv50” refers to protein network comprising casein micelles and whey proteins either present in aggregates. At pH below 6.5 the whey proteins show a strong tendency to form covalent aggregates with the casein micelles.

The mean diameter value Dv50 of the milk powder of the present invention ranges from 1 μm-60 μm. In one embodiment the Dv50 value ranges from 2 μm-25 μm. In another embodiment the Dv50 value ranges from 3 μm-20 μm. In yet another embodiment the d value ranges from 5 μm-10 μm.

In one embodiment, the present invention also relates to a process for preparing a milk powder comprising the steps of: a) Providing a liquid milk concentrate at temperature below 25° C.; b) Adjusting pH between 5.7 and 6.4; c) Heat treating the composition at 80-150° C. for 3-300 seconds such that the obtained composition retains a mean diameter value Dv50 of at least 1 μm as measured by laser diffraction; d) Cooling the composition below 70° C. preferably below 60 and optionally readjusting the pH between 6.5 to 6.8; and drying the composition after step d. In one embodiment of the present invention the drying is spray dried form using low pressure drying system. The mean diameter value Dv50 may range from 5-30 μm. The mean diameter value Dv50 may also range from 5-10 μm.

In one embodiment, the heat treatment of step c) mentioned above ranges from 80-100° C. for 30-300 seconds or at 130-150° C. for 3 to 15 seconds.

It has been shown during the experiments leading to this invention that the reconstituted spray dried milk powder when reconstituted at total solids between 35 to 50% (w/w) exhibits a shear viscosity of at least 1000 mPa·s measured at a shear stress of 10 Pa, a shear viscosity of at least 400 mPa·s measured at a shear rate of 100 l/s and a viscosity ratio between these two conditions of at least 1.3 as determined on flow curves obtained with a rheometer at 20° C. All compositions processed outside the conditions of the invention were not able to fulfill these 3 criteria simultaneously, indicating that the structure formed by the protein complex together with the fat droplets had a direct influence on the flow behavior of the system, and possibly on its textural properties.

In another embodiment, the present invention also relates to a process for preparing a milk powder comprising the steps of: a) Providing a liquid milk concentrate at temperature below 25° C.; b) Adjusting pH between 5.7 and 6.4; c) Heat treating the composition at 80-150° C. for 3-300 seconds such that the obtained composition exhibits a shear viscosity of at least at least 1000 mPa·s measured at a shear stress of 10 Pa, a shear viscosity of at least 400 mPa·s measured at a shear rate of 100 l/s and a viscosity ratio between these two conditions of at least 1.3 as determined on flow curves obtained with a rheometer at 20° C. at a concentration of at least 35% (w/w); d) Cooling the composition below 70° C. and optionally readjust the pH between 6.5 and 6.8; and drying the composition after step d. In one embodiment of the present invention the drying is spray dried form using low pressure drying system. In one embodiment the step d) is performed below 60° C.

In a particular embodiment of the present invention, the dried milk powder is characterized by a low amount of air present in the powder granules after drying. More specifically the volume fraction of air in the powder granules is less than 2% as determined by image analysis performed on section of powder granules embedded in a historesin.

In a particular embodiment of the present invention, the drying is spray drying and the spray dried milk powder is characterized by a surprisingly low amount of air present in the powder granules after spray drying. More specifically the volume fraction of air in the powder granules is less than 2% as determined by image analysis.

The term “upon reconstitution in an aqueous medium” refers to reconstituting the milk powder into a liquid such as water. The liquid may be milk. Such a process is carried out typically at room temperature and may involve stirring means. The process may be carried out at elevated temperature, e.g. 85° C. for a hot beverage preparation.

It has surprisingly been found that texture and mouthfeel of dried milk powder is enhanced as a result of an optimized process of preparation including the controlled use of heat and acidic conditions.

These protein aggregates form a network that is suspected of binding water and entrapping fat globules (in case of presence of fat) and increases mix viscosity to create a uniquely smooth, creamy texture that mimics the presence of higher fat levels.

In one embodiment of the present invention, the spray-dried milk composition does not include any thickeners and/or stabilisers. Examples of such thickeners include hydrocolloids, e.g. xanthan gum, carrageenans, guar gum, locust bean gum or pectins as well as food grade starches or maltodextrins.

Several types of atomization are known for spray drying such as centrifugal wheel, hydraulic (high) pressure-nozzle, pneumatic (two phase nozzle) and sonic atomization. The term “low pressure drying system” refers to centrifugal wheel or pneumatic atomization systems which protects the structure of the casein-whey protein aggregates. It has been observed that high pressure atomizers such as hydraulic (high) pressure-nozzle atomization results in shearing effect thus destroying the casein-whey protein aggregates and thus its unique functionality. Such high pressure atomizers are useful for making conventional milk powders; however such a high-pressure system is not suitable for producing samples of the present invention.

In one embodiment the milk powder of the present invention is used in producing tea and coffee mixes. In another embodiment the milk powder of the present invention is used for manufacturing of culinary sauces or cocoa-malt-beverages.

In another embodiment, the milk powder of the invention is dried with other methods of drying milk such as freeze drying and roller drying as alternative processes to achieve the intended product benefits. In particular the processes achieve a milk powder when reconstituted in aqueous medium results in casein-whey protein aggregate having a mean diameter value Dv50 ranging from 5-30 μm. The mean diameter value Dv50 may also range from 5-10 μm. In particular the processes achieve a milk powder upon reconstitution in an aqueous medium at a minimum of 35% (w/w) total solids exhibits a shear viscosity of at least 1000 mPa·s measured at a shear stress of 10 Pa, a shear viscosity of at least 400 mPa·s measured at a shear rate of 100 l/s and a viscosity ratio between these two conditions of at least 1.3 as determined on flow curves obtained with a rheometer at 20° C.

It should be noted that embodiments and features described in the context of one of the aspects of the present invention also apply to the other aspects of the invention.

The invention will now be described in further details in the following non-limiting examples.

### EXAMPLES

### Example 1

### Reference 1

This reference represents a standard whole milk powder purchased from Emmi® full milk powder containing water 3.1%, protein (N×6.38) 24.6%, fat 27.1% and pH is 6.5. Process conditions are unknown. Hence another reference was used as described below.

### Reference 2 (Refer Table Below)

Raw milk (protein, N×6.38) 3.4%, fat 4.0%, total solids 12.8% is preheated to 60° C. by a plate heat exchanger and homogenized by a Gaulin MC 15 10OTBSX high pressure homogenizer (250 bars). Subsequently, the homogenized milk is concentrated by a Scheffers 3 effects falling film evaporator (from Scheffers B.V.) to 35% total solids. The milk concentrate is cooled by a plate heat exchanger to 4° C. and pH of homogenized liquid milk concentrate was measured to be 6.5. The composition is preheated again to 60° C. by a plate heat exchanger and subsequently heated to 85° C. by direct steam injection system (self-construction of Nestlé) with a holding time of 15 seconds. After the heat treatment, the milk concentrate is rapidly cooled down by a 3VT460 CREPACO scrape heat exchanger (from APV Invensys Worb) to 40° C. The milk concentrate is then spray dried on a Nestlé 3.5 m Egron (self-construction) by a two-phase nozzle system (1.8 mm nozzle) to maximal moisture content of 3% and packed into air tight bags. Conditions of spray drying were: product flow of 413 kg/h at 37° C. product temperature, hot air inlet temperature of 270° C. and an air flow of 4664 kg/h, outlet air temperature of 88° C.

### Sample 1 of Present Invention

Raw milk is preheated to 60° C. by a plate heat exchanger and homogenized by a Gaulin MC 15 10OTBSX high pressure homogenizer (250 bars). Subsequently, the homogenized milk is concentrated by a Scheffers 3 effects falling film evaporator (from Scheffers B.V.) to approximately 35% total solids. The milk concentrate is cooled by a plate heat exchanger to 4° C. and pH adjusted to 6.0 using citric acid. The pH adjusted milk concentrate is preheated again to 60° C. by a plate heat exchanger and subsequently heated to 95° C. by direct steam injection system (self-construction of Nestlé) with a holding time of around 300 seconds. After the heat treatment, the milk concentrate is rapidly cooled down by a 3VT460 CREPACO scrape heat exchanger (from APV Invensys Worb) to 40° C. The milk concentrate is then spray dried on a NIRO SD6 3N spray dryer by a rotary disc nozzle system at 17,000 rpm to maximal moisture content of 3% and packed into air tight bags. Conditions of spray drying were: product flow of 20 L/h at 40° C. product temperature, hot air inlet temperature of 160° C. and an air flow of 360 m³/h, outlet air temperature of 80° C.

### Sample 2 of Present Invention

Raw milk is preheated to 60° C. by a plate heat exchanger and homogenized by a Gaulin MC 15 10OTBSX high pressure homogenizer (250 bars). Subsequently, the homogenized milk is concentrated by a Scheffers 3 effects falling film evaporator (from Scheffers B.V.) to 50% (w/w) total solids. The milk concentrate is cooled by a plate heat exchanger to 4° C. and pH adjusted to 6.1 using citric acid. The pH adjusted milk concentrate is preheated again to 60° C. by a plate heat exchanger and subsequently heated to 90° C. by direct steam injection system (self-construction of Nestlé) with a holding time of 150 seconds. After the heat treatment, the milk concentrate is rapidly cooled down to 40° C. by a 3VT460 CREPACO scrape heat exchanger (from APV Invensys Worb). The milk concentrate is then spray dried on a Nestlé 3.5 m Egron (self-construction) by a two-phase nozzle system (1.8 mm nozzle) to maximal moisture content of 3% and packed into air tight bags. Conditions of spray drying were: product flow of 392 kg/h at 48° C. product temperature, hot air inlet temperature of 233° C. and an air flow of 4821 kg/h, outlet air temperature of 86° C.

### Samples 3 to 6 of the Present Invention

Samples 3 to 6 are produced according to the same procedure, involving: concentration of a commercial whole milk to a variable level of total solid content, adding a variable amount of different acids to reach a specific target pH value in the milk concentrate, standardized heat processing including a direct steam injection step, and spray drying to obtain a functionalized milk powder. The following details apply:

TABLE 1
Characteristics of samples 3 to 6 of the present invention.

| | Total solid | | | |
|---|---|---|---|---|
| | content of | | | |
| | whole milk | | Acid | |
| Sample | concentrate | | concentration | Target |
| # | (wt %) | Acid type | (wt %) | pH |
| 3 | 25 | Citric acid | 5 | 6.1 |
| 4 | 37 | Citric acid | 5 | 6.2 |
| 5 | 25 | Hydrochloric acid | 2 | 6.1 |
| 6 | 37 | Phosphoric acid | 5 | 6.2 |

Raw material: Commercially available, pasteurized and microfiltrated, homogenized whole milk (3.5% fat content, Cremo, Le Mont-sur-Lausanne, CH) is concentrated to a total solid content as indicated in the table 1, with a Centritherm® CT1-09 thin film spinning cone evaporator (Flavourtech Inc., AU).

Concentration: The concentration process is done in recirculating batch mode, starting with milk at 4° C. The milk is pumped with a progressing cavity pump, from a buffer tank through a plate heat exchanger set to 40° C. outlet temperature and the Centritherm® CT1-09 evaporator, back into the buffer tank. The milk in the buffer tank thereby gradually increases in solid concentration and temperature. When a critical concentration threshold is reached, the milk is brought to the desired total solids content by a final evaporator pass without remixing, and collected in a separate holding tank. The following process parameters are used: flow rate 100 l/h, evaporator inlet temperature 40° C., evaporator vacuum pressure 40-100 mbar, evaporator steam temperature 90° C. This results in concentrate outlet temperatures of around 35° C., and evaporate flow rates which decrease gradually from about 50 l/h to 30 l/h with increasing milk concentration. High product flow rates around 100 l/h and a stable product inlet temperature of 40° C. are essential to avoid fouling of the milk concentrate on the heat exchange surface of the Centritherm® device.

pH adjustment: The milk concentrate is cooled to 10° C. and its pH adjusted at this temperature with a temperature-compensated pH meter Handylab pH 11 (Schott Instruments, D) to the pH value and with the acid as indicated in table 1, under agitation, step-wise, and avoiding local overconcentration of acid. Typical dilution of the milk concentrate by acidifying is in the order of 1-3% relative, depending on final pH, acid type and concentration. The typical timeframe for pH adjustment of a 40 kg batch is about 15 minutes.

Heat treatment: The cooled, acidified milk concentrate is heat-processed in semi-continuous mode on a commercially available OMVE HT320-20 DSI SSHE pilot plant line (OMVE Netherlands B.V., NL). Processing steps are: preheating in the OMVE tubular heat exchanger to 60° C., direct steam injection to 95° C. outlet temperature, 300 sec hot holding period at 95° C. in the two scraped surface heat exchangers of the OMVE line, connected in series and running at maximum rpm, and subsequent cooling to about 23° C. product outlet temperature the OMVE tubular heat exchanger cooled with ice water. Flowrate is set to 14 l/h to obtain a sum of approximately 300 sec residence time in the scraped surface heat exchanger units. Residence time in the OMVE cooler is about 2 minutes. Residence times are averages from volumetric flow rates and dead volume of line elements (tubular heat exchanger, scraped surface heat exchanger). Clogging of the DSI injector is a critical phenomenon, and the line must be carefully controlled in this respect. No flash evaporation is applied and condensing steam remains entirely in the product.

Powder production: The acidified, heat-processed milk concentrate is spray-dried on a Niro SD 6.3 pilot plant spray tower (GEA NIRO Process Engineering, DK), equipped with a FS1 rotary atomizer. Operating parameters are: Product feed rate 10-20 kg/h, product inlet temperature in the rotary atomizer 25-30° C., rotary atomizer speed 25000 rpm, airflow 350-400 kg/h (mass flow control), air inlet temperature 160° C., exhaust air temperature 80° C. and exhaust air relative humidity 15%. The finished powder product is packed immediately in air-tight bags and has a residual humidity below 4%.

### Sample 7 of Present Invention

Pasteurized skim milk is preheated to 60° C. by a plate heat exchanger and subsequently, the skimmed milk is concentrated by a Scheffers 3 effects falling film evaporator (from Scheffers B.V.) to 45% (w/w) total solids. The milk concentrate is cooled by a plate heat exchanger to 4° C. and pH adjusted to 6.0 using citric acid. The pH adjusted milk concentrate is preheated again to 60° C. by a plate heat exchanger and subsequently heated to 90° C. by direct steam injection system with a holding time of 150 seconds. After the heat treatment, the milk concentrate is rapidly cooled down to 40° C. by a 3VT460 CREPACO scrape heat exchanger (from APV Invensys Worb). The milk concentrate is then spray dried by a two-phase nozzle system (1.8 mm nozzle) to maximal moisture content of 3% and packed into air tight bags. Conditions of spray drying were: product flow of 392 kg/h at 60° C. product temperature, hot air inlet temperature of 248° C. and an air flow of 4772 kg/h, outlet air temperature of 88° C.

### Example 2

### Size Distribution Measurements

The milk powders of the present invention were compared to the above references and were characterized by laser diffraction in order to determine particle size distribution (PSD=Particle Size Distribution)

Results are shown in table 1 below wherein the PSD measured by laser diffraction represents a mean value Dv50 (μm).

The size of particles, expressed in micrometers (μm) at 50% of the cumulative distribution was measured using Malvern Mastersizer 2000 (references 1 and 2, samples 1 and 2) or Mastersizer 3000 (samples 3 to 6 of present invention) granulometer (laser diffraction unit, Malvern Instruments, Ltd., UK). Ultra pure and gas free water was prepared using Honeywell water pressure reducer (maximum deionised water pressure: 1 bar) and ERMA water degasser (to reduce the dissolved air in the deionised water).

Powdered samples were reconstituted before measurements. Distilled water was poured into a beaker and heated up to 42° C.-44° C. with a water bath. A volume of 150 mL distilled water at 42° C.-44° C. was measured and transferred into a glass beaker using a volumetric cylinder. An amount of 22.5 g milk powder is added to the 150 ml distilled water at 42° C. and mixed with a spoon for 30 s.

Dispersion of the liquid or reconstituted powder sample in distilled or deionised water and measurements of the particle size distribution by laser diffraction.

Measurement settings used are a refractive index of 1.46 for fat droplets and 1.33 for water at an absorption of 0.01. All samples were measured at an obscuration rate of 2.0-2.5%.

The measurement results are calculated in the Malvern software based on the Mie theory. The resulting Dv50 obtained for the 4 samples are presented in table 2.

TABLE 2
Dv50 (in microns) of reconstituted powders
as determined by laser diffraction.

| Refer- | Refer- | Sam- | Sam- | Sam- | Sam- | Sam- | Sam- | Sam- |
|---|---|---|---|---|---|---|---|---|
| ence 1 | ence 2 | ple 1 | ple 2 | ple 3 | ple 4 | ple 5 | ple 6 | ple 7 |
| 0.394 | 0.568 | 29.482 | 18.417 | 10.4 | 14.2 | 40.7 | 10.2 | 7.330 |

### Microstructure of the Liquid Samples Before Spray Drying, Reconstituted Powders or Spray Dried Powders

### Liquid Samples Before Spray Drying

The microstructure of the systems was investigated either directly in liquid samples before spray drying, in the reconstituted powders or the powders were directly investigated.

For investigation of liquid samples, a Leica DMR light microscope coupled with a Leica DFC 495 camera was used. The systems were observed using the differential interference contrast (DIC) mode. An aliquot of 500 microliters of liquid sample was deposited on a glass slide and covered with a clover slide before observation under the microscope.

### Reconstituted Powders

The reconstituted powders of reference 2 and sample 1 of the invention have been investigated by confocal scanning laser microscopy for imaging of fats and proteins in dissolved milk powders. The powders were weighted in a beaker to achieve a w/v concentration of 15% for the reference 2 powder and 7.5% for the sample 1 powder. The dissolution was achieved using 150 ml of hot Vittel™ water (70° C.), delivered by a DolceGusto™ machine (5 slots). The dissolution was completed by a manual stirring.

The proteins were stained using an aqueous solution of fast green (Fast green, FCF, C.I. 42053, ICN Biochemicals, 1% w/v) and fats using an ethanol solution of Nile red (N3013, Sigma) 25 mg/100 ml). Ten ml of the milk solution were sampled, to which 1 ml and 100 μl, respectively of the fast green and Nile red solutions were added.

A volume of 200 μl of the stained milk was deposited in a 1 mm deep plastic observation changer and covered with a cover slide. The confocal imaging is carried out with a Zeiss LSM 710 confocal microscope at a 488 nm excitation wavelength (emission bandwidth=505-600) for the Nile red and 633 nm for the Fast green (emission bandwidth=640-700).

### Spray Dried Milk Powders

The reference 2 and sample 1 spray dried milk powders were investigated using resing embedding and sectioning followed by toluidine blue staining of the proteins. To this aim, a fixative composed by 3 parts acetone 100%+1 par glacial acetic acid was prepared together with an embedding resin (resin Technovit 7100, Haslab).

Sample fixation was performed by pre-cooling the fixative (10 ml) at a temperature of −10° C. in a glass vials. For the fixation, 1.5 g of the powder are dispersed in the fixative.

After 24 hours the fixative is removed and replaced by pre-cooled acetone and the powder re-dispersed. If the powder is agglomerated, it is reduced in smaller pieces ˜5 mm each. After 2-3 hours, the same operation is repeated with pre-cooled mixtures of, successively, ⅔ acetone-⅓ resin (3 hours), ⅓ acetone-⅔ resin (3 hours), pure resin (overnight). The resin infiltration is finalized at 4° C. by 2 bathes of pure resin, 2 hours each.

The polymerization is achieved in Teflon molds at room temperature following the supplier's instructions.

Histoblocks are glued at the top of the polymerized Technovit 7100 blocks using Technovit 3040 (Haslab). They are sliced onto 4 um thin sections with a Jung Autocut 2055 microtome (Leica AG), with a tungsten knife.

Once dried, the sections are stained with a 1% aqueous solution of toluidine blue for 5 minutes, dried, and mounted with Eukitt.

The images are acquired, under constant illumination conditions on a BX51 Olympus microscope using home-made Image analysis software based on VB6 and the IO image objects tool kits from Synoptics (UK), at a final magnification of ×230

With the toluidine blue staining the air bubbles enclosed within the milk particles appear white in a blue to purple matrix. The color images are converted to grey then processed successively by a median, a ranking and a bilinear fitting filter. This process is automated. Then, a grey level threshold is determined manually to highlight the matrix of the milk particles. The same threshold is applied to the all images.

The result is a binary image displaying the matrix in white and the pores as black holes. These holes are filled to calculate the total area of the particles (Ta). Then, an algorithm is applied to convert the holes (the pores) into a binary image thereby allowing calculating the total air area (Tair). The rules of morphometry demonstrates that statistically the ratio Tair/Ta is equivalent the volume fraction of air.

### Flow Behavior of the Reconstituted Powders

After reconstitution to 50% total solids in water at 50° C., the flow behavior of reference 2 spray dried at 50% total solids and sample 2 of the present invention was characterized using a Haake RheoStress 6000 rheometer coupled with temperature controller UMTC-TM-PE-P regulating to 20+/−0.1° C. The measuring geometry was a plate-plate system with a 60 mm diameter and a measuring gap of 1 mm.

The flow curve was obtained by applying a controlled shear stress to a 3 mL sample in order to cover a shear rate range between 0 and 300 l/s (controlled rate linear increase) in 180 seconds.

From the flow curves, the shear viscosities corresponding to a stress of 10 Pa and a shear rate of 100 l/s were determined. As well, the viscosity ratio from the two conditions was calculated and all data are reported in table 3.

TABLE 3
Rheological properties determined at 20° C. for
spray dried powders reconstituted at 50% total solids.

| reference 2 | reference 2 | | sample 2 | sample 2 | |
|---|---|---|---|---|---|
| shear | shear | | shear | shear | |
| viscosity at a | viscosity at a | | viscosity at a | viscosity at a | |
| shear stress | shear rate | reference 2 | shear stress | shear rate | sample 2 |
| of 10 Pa | of 100 1/s | viscosity | of 10 Pa | of 100 1/s | viscosity |
| (mPa · s) | (mPa · s) | ratio | (mPa · s) | (mPa · s) | ratio |
| 280 | 218 | 1.28 | 6300 | 3250 | 1.94 |

Similar procedure was used to characterize the flow behavior of samples 3 to 6 according to the invention after reconstitution to 50% (w/w), but the experimental device was changed. In this case, a controlled-stress Rheometer MCR-502 coupled with a Peltier cell type P-PTD200/56 regulated at 20+/−0.1° C. (Anton Paar). The measuring geometry was plate-plate (smooth surface) type PP50 with a 50 mm diameter and a measuring gap of 1 mm. The flow curve was obtained by applying a controlled shear stress to a 3 mL sample in order to cover a shear rate range between 0 and 300 l/s (controlled rate linear increase) in 180 seconds.

### Example 3

### Sensory Characteristics—Mouthfeel

The panelists were given following samples as described in table 4 below.

TABLE 4
Amount of spray dried milk powders used for sensory test

| Reference 2 | Sample 2 of invention |
|---|---|
| 10% of powder in | 10% of powder in end |
| end cup | cup |

Sample preparation for 1 L final beverage was 105 g powder, 8 g soluble coffee, 5 g buffer salts filled up to 1 L by tapped water.

The serving temperature was 85° C. The panelists (35) were asked to rank the samples according to overall difference and mouthfeel to a blind version of Reference A:
1) Overall difference: from no difference to big difference (0-10) and
2) Mouth feel: less mouth feel to more mouth feel (−5 to 5)
The results are shown in below table 5. Sample of invention is significantly perceived as different in comparison to the reference (overall difference) and with slightly more mouth feel then reference. Anova: 90% confidence level.

TABLE 5

| Samples | Overall (0/10) | Mouthfeel (−5/5) |
|---|---|---|
| Reference 2 | 2.92 | −0.04 |
| Sample 2 of invention | 4.95 | 1.23 |

### Example 4

### Sensory Characteristics—Fat Reduction

The panelists were given following samples as described in table 6 below.

TABLE 6
Amount of spray dried milk powders used for sensory test

| Reference 2 | Sample 3 of invention |
|---|---|
| 12% of powder in | 12% of powder in end |
| end cup | cup |

Sample preparation for 1 L final beverage was 125 g powder, 6.3 g soluble coffee, 5 g buffer salts, 36 g sugar filled up to 1 L by tapped water.

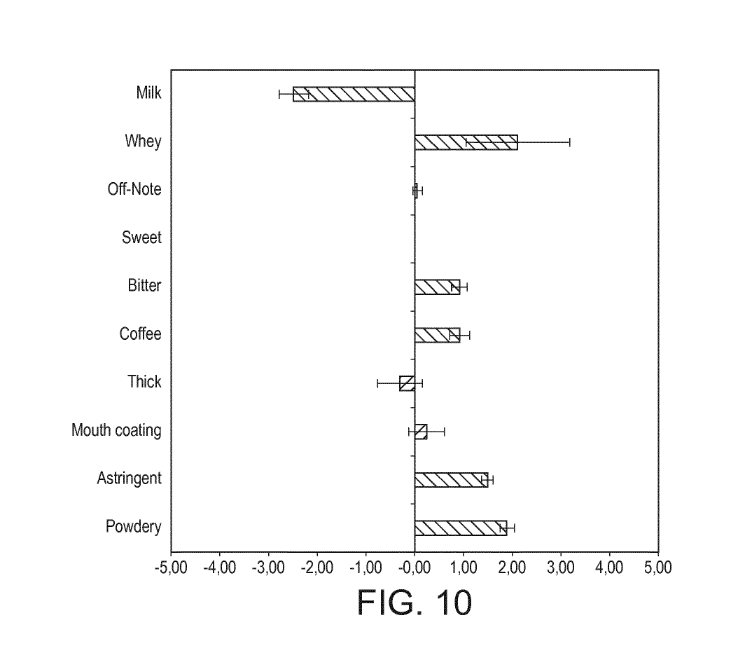

The serving temperature was 65° C. The professional panelists (15) were asked for a comparative profiling of reference 2 to sample 3 of present invention. The results are shown in FIG. 10. Sample of invention is shows no significant difference in mouthcoating and thickness in comparison to the reference 2. The difference in whey and milk note is coming from the absence of fat. Anova: 90% confidence level.

1. A milk powder comprising caseins and whey proteins wherein the powder upon reconstitution in an aqueous medium comprises casein-whey protein/fat aggregates having a mean diameter value Dv50 of at least 1 μm as measured by laser diffraction.

2. The milk powder of claim 1, wherein the mean diameter value Dv50 ranges from 1 μm-60 μm.

3. The milk powder of claim 1, wherein the mean diameter value Dv50 ranges from 5-10 μm.

4. The milk powder of claim 1 which exhibits a volume fraction of air in the powder granules of less than 2% as determined by image analysis.

5. The milk powder of claim 1, wherein upon reconstitution in an aqueous medium at a minimum of 35% (w/w) total solids exhibits a shear viscosity of at least 1000 mPa·s measured at a shear stress of 10 Pa, a shear viscosity of at least 400 mPa·s measured at a shear rate of 100 l/s and a viscosity ratio between these two conditions of at least 1.3 as determined on flow curves obtained with a rheometer at 20° C.

6. The milk powder of claim 1 comprising a semi-skimmed, skimmed and/or whole milk powder.

7. A process for preparing a milk powder comprising caseins and whey proteins wherein the powder upon reconstitution in an aqueous medium comprises casein-whey protein/fat aggregates having a mean diameter value Dv50 of at least 1 μm as measured by laser diffraction, comprising the steps of:
providing a liquid milk concentrate at temperature below 25° C.;
adjusting pH between 5.7 and 6.4;
heat treating the composition at 80-150° C. for 3-300 seconds;
cooling the composition below 70° C. and optionally readjusting the pH between 6.5 and 6.8; and
drying the composition.

8. A process of claim 7, wherein the drying is spray drying form using low pressure drying system.

9. A method for producing a powdered product selected from the group consisting of growing up milks, culinary sauces, coffee mixes, tea creamer and cocoa-malt beverages comprising using a milk powder comprising caseins and whey proteins wherein the powder upon reconstitution in an aqueous medium comprises casein-whey protein/fat aggregates having a mean diameter value Dv50 of at least 1 μm as measured by laser diffraction to produce the powdered product.
